(19) United States
(12) Patent Application Publication
(10) Pub. No.: US 2026/0234486 A1
(43) Pub. Date: Aug. 13, 2026

(54) LUBRICANT INCLUDING AN ESTER OF PYROMELLITIC ACID FOR REFRIGERATION SYSTEMS

(71) Applicant: The Lubrizol Corporation, Wickliffe, OH (US)

(72) Inventors: Bridgett K. Rakestraw, Midland, MI (US); David M. Pallister, Highland, MI (US); Andrew D. Sumner, Midland, MI (US); Scott Miller, Midland, MI (US); Zhana Adams, Flint, MI (US)

(73) Assignee: The Lubrizol Corporation, Wickliffe, OH (US)

(21) Appl. No.: 19/148,198

(22) PCT Filed: Jan. 17, 2024
(86) PCT No.: PCT/US2024/011800

§ 371 Date: Jul. 15, 2025

Related U.S. Application Data
(60) Provisional application No. 63/439,643, filed on Jan. 18, 2023.

(51) Int. Cl. C10M 105/36; C09K 5/04; C10M 105/38; C10N 40/30

(52) U.S. Cl. CPC C10M 105/36; C09K 5/044; C09K 5/045; C10M 105/38; C09K 2205/126; C09K 2205/24; C10M 2207/2835; C10M 2207/2855; C10N 2040/30

(57) ABSTRACT

A working fluid includes a lubricant and a refrigerant. The lubricant includes a tetra-alkyl ester of pyromellitic acid (1,2,4,5-benzenetetracarboxylic acid) and the refrigerant may include a hydrofluoroolefin. A method of lubricating a compressor of a refrigeration system includes forming a working fluid in the refrigeration system. The working fluid includes a lubricant and a refrigerant. The lubricant includes a tetra-alkyl ester of pyromellitic acid and the refrigerant may include a hydrofluoroolefin.

This application claims the benefit of PCT Application No. PCT/US2024/011800, filed Jan. 17, 2024, and U.S. Provisional Application No. 63/439,643, filed Jan. 18, 2023, from which the PCT application claims priority, the disclosures of which are incorporated herein by reference in their entireties.

### BACKGROUND

The exemplary embodiment relates to a working fluid for a compressor of a cooling system and finds particular application in connection with a working fluid which includes a lubricant containing a tetra-alkyl ester of pyromellitic acid and a hydrofluoroolefin-based refrigerant.

Cooling systems are widely used for cooling air in domestic and commercial refrigerators, automobiles, refrigerated transport vehicles, heat pumps, and air conditioners. Such systems generally include a compressor for pressurizing the gaseous refrigerant before it enters a condenser. The compressor is lubricated by a lubricant, which should be compatible with the refrigerant being used. Due to the potential damage to the ozone layer by chlorofluorocarbon refrigerants (CFCs), refrigerants with low or no chlorine content, such as hydrofluoroolefin refrigerants (HFOs), are being considered as replacements. HFOs are composed solely of hydrogen, fluorine and carbon atoms and contain at least one double bond between the carbon atoms.

Conventional lubricants for compressors, such as polyolester (POE)-based lubricants, tend not to provide the miscibility/solubility properties needed to enable these new refrigerants to perform satisfactorily and meet the system performance requirements set forth by the hardware manufacturers. Aromatic esters have been considered as potential components of a lubricant that may be used with hydrofluorocarbon-based refrigerants. For example, U.S. Pub. No. 20200318023A1, published Oct. 8, 2020, entitled AROMATIC ESTER LUBRICANT FOR USE WITH LOW GLOBAL WARMING POTENTIAL REFRIGERANTS, by Bujouves, et al., describes a working fluid for a refrigeration system including a refrigerant, and a lubricant that includes at least one aromatic ester and a polyolester.

Another aromatic ester based on gallic acid is described in U.S. Pub. No. 20150307762A1, published Oct. 29, 2015, entitled REFRIGERATING MACHINE OIL AND WORKING FLUID COMPOSITION FOR REFRIGERATING MACHINE, by Saito, et al.

JP5546726B2, published Jul. 9, 2014, entitled REFRIGERATOR OIL AND WORKING FLUID COMPOSITION FOR REFRIGERATOR, describes a working fluid composition for a refrigerator which contains an ester of an aromatic carboxylic acid selected from phthalic acid, isophthalic acid, terephthalic acid, trimellitic acid, and pyromellitic acid, an aliphatic dihydric alcohol having 2 to 15 carbon atoms, and a 2,3,3,3-tetrafluoropropene.

GB2216541A, published Oct. 11, 1989, entitled WORKING FLUID/LUBRICANT COMBINATION, describes a working fluid/lubricant combination for use in a mechanical vapor recompression type heat transfer device. The working fluid includes a hydrofluorocarbon, hydrochlorofluorocarbon, or chlorofluorocarbon and the lubricant includes an ester having a molecular weight greater than 250, such as tetrabutyl pyromellitate.

WO200174977A2, published Oct. 11, 2001, entitled LUBRICANT AND FLUSHING COMPOSITIONS, describes a lubricant composition including an ester derivable from the reaction of an aromatic monocarboxylic acid with a monovalent aliphatic alcohol having 1 to 15 carbon atoms.

EP0461435, published Aug. 24, 1994, entitled APPLICATION OF AROMATIC CARBOXYLIC ESTERS AS LUBRICANT IN REFRIGERANT COMPRESSORS, describes esters produced from aromatic carboxylic acids and monohydric alcohols as lubricants for refrigerant compressors which are operated with chlorine-free, partially fluorinated hydrocarbons as refrigerants. The esters can be derived from aromatic carboxylic acids, such as trimellitic acid and pyromellitic acid and straight-chain or branched, primary monohydric alcohols having 4 to 20 carbon atoms.

JP2009155463 A, published Jul. 16, 2009, describes a working fluid including an ester of pyromellitic acid.

### BRIEF DESCRIPTION

In accordance with one aspect of the exemplary embodiment, a working fluid includes a lubricant and a refrigerant. The lubricant includes a tetra-alkyl ester of pyromellitic acid.

In the working fluid, the tetra-alkyl ester of pyromellitic acid may be at least 80 wt. %, at least 90 wt. %, or at least 95 wt. %, or at least 98 wt. % of the lubricant.

The alkyls in the tetra-alkyl ester of pyromellitic acid may be selected from linear and branched alkyl groups comprising at least 5 carbon atoms, and mixtures thereof. Each of the alkyls may be selected from linear and branched alkyl groups including at least 6, carbon atoms, or at least 8 carbon atoms, or up to 14 carbon atoms, or up to 12 carbon atoms, or up to 10 carbon atoms.

In the working fluid, the lubricant may be more than 10 wt. %, or no more than 5 wt. %, or no more than 2 wt. %, or no more than 1 wt. %, or no more than 0.1 wt. %, or 0 wt. % of polyol esters, polyol ethers, and mixture thereof.

The working fluid may include a total of no more than 10 wt. %, or no more than 1 wt. %, or no more than 0.5 wt. %, or at least 0.005 wt. %, or at least 0.01 wt. %, or at least 0.1 wt. % of at least one additive selected from the group consisting of corrosion inhibitors, foam inhibitors, lubricity additives, surfactants, and combinations thereof.

A ratio of fluorine atoms to chlorine atoms in the refrigerant may be at least 1:1, or at least 2:1, or at least 3:1, or at least 4:1, or at least 5:1, or at least 6:1, or at least 10:1, or at least 99:1.

The refrigerant in the working fluid of any preceding claim may include at least one hydrofluoroolefin.

In the working fluid, the at least one hydrofluoroolefin may be selected from the group consisting of 2,3,3,3-tetrafluoropropene; 1,3,3,3-tetrafluoropropene; 3,3,3-trifluoropropene; 1,2,3,3,3-pentafluoropropene; 1,1,1,4,4,4-hexafluoro-but-2-ene; 1,1,1,4,4,4-hexafluoro-but-2-ene; 1,1,1,4,4,5,5,5-octafluoropent-2-ene; and mixtures thereof.

The at least one hydrofluoroolefin may be at least 80 wt. %, or at least 90 wt. %, or at least 95 wt. %, or 100 wt. % of all halocarbons in the working fluid.

The tetra-alkyl ester of pyromellitic acid and hydrofluoroolefin, in combination, may be at least 90 wt. %, or at least 95 wt. %, or up to 100 wt. % of the working fluid.

In the working fluid, a ratio by weight of the tetra-alkyl ester of pyromellitic acid to the refrigerant in the working fluid may be from 1:99 to 99:1.

The working fluid as described in any of the embodiments herein may find use in a refrigeration system comprising a compressor and an evaporator.

In another aspect of the exemplary embodiment, a method of lubricating a compressor of a refrigeration system includes forming a working fluid in the refrigeration system, the working fluid including a lubricant and a refrigerant, the lubricant comprising a tetra-alkyl ester of pyromellitic acid, the refrigerant comprising a hydrofluoroolefin.

In the method, the forming of the working fluid comprises supplying the lubricant to a compressor of the refrigeration system, the lubricant mixing with the refrigerant in the compressor to form the working fluid.

In the method in the compressor, the lubricant may reach a maximum concentration in the working fluid of at least 1 wt. %, or at least 5, wt. %, or at least 10 wt. %, or at least 15 wt. %, or at least 20 wt. %, or up to 25 wt. %.

In this method the four alkyls of the tetra-alkyl ester of pyromellitic acid may be selected from linear and branched alkyl groups comprising at least 5 carbon atoms, and mixtures thereof. Each of the alkyls is independently selected from linear and branched alkyl groups comprising at least 6, carbon atoms, or at least 8 carbon atoms, or at least 9 carbon atoms, or up to 14 carbon atoms, or up to 12 carbon atoms, or up to 10 carbon atoms.

In another aspect of the exemplary embodiment, a method of improving solubility of hydrofluoroolefin refrigerant in a working fluid comprising supplying a lubricant to the working fluid, the lubricant comprising a tetra-alkyl ester of pyromellitic acid.

In another aspect of the exemplary embodiment, a method of reducing the occurrence of lubricant foam in an hydrofluoroolefin refrigerant includes supplying a lubricant to the hydrofluoroolefin refrigerant, the lubricant comprising a tetra-alkyl ester of pyromellitic acid.

In the method, the reduction of foam may result from improved release of refrigerant vapor from the lubricant.

### BRIEF DESCRIPTION OF THE DRAWINGS

FIG. 1 is a block diagram of a refrigeration system in accordance with one aspect of the exemplary embodiment;

FIG. 2 is a plot of kinematic viscosity vs temperature for a working fluid containing a pyromellitate tetraester in accordance with the exemplary embodiment; and

FIG. 3 is a plot of kinematic viscosity vs temperature for a working fluid containing a comparative polyol ester/trimellitate blend.

### DETAILED DESCRIPTION

Aspects of the exemplary embodiment relate to a lubricant which includes a tetra-alkyl ester of pyromellitic acid (1,2,4,5-benzenetetracarboxylic acid) (or its dianhydride) and to a working fluid which includes a refrigerant and the exemplary lubricant, and to methods of lubricating a refrigeration system.

The exemplary lubricants tend to have improved miscibility with low or no chlorine refrigerants (LCRs), such as HFO refrigerants, and can provide improved wear and lower foaming properties, when compared to existing lubricants. However, the exemplary lubricants are not limited to use with LCRs.

As used herein, the term “refrigeration system” refers generally to any system, or any part or portion of such a system, which employs a refrigerant to provide cooling and/or heating. Such refrigeration systems include, for example, air conditioners, electric refrigerators, chillers, heat pumps, organic Rankine cycle systems, and the like. The exemplary lubricant finds particular use in a compression refrigeration system, such as an air conditioning system, heat pump, or an organic Rankine cycle system, in which a refrigerant is circulated. The refrigerant is a fluid which is used in the refrigeration cycle of the refrigeration system. It generally undergoes a repeated phase transition from a liquid to a gas and back again. The lubricant combines with the refrigerant to form a working fluid. A ratio by weight of the lubricant to the refrigerant in the working fluid typically varies throughout the refrigeration cycle, with a maximum weight ratio of lubricant:refrigerant of at least 1:99, or at least 5:95, or at least 10:90, or up to 40:60, or up to 30:70, apart from in the compressor itself, where the lubricant:refrigerant ratio may be higher, such as up to 99:1, or higher.

### The Lubricant

The tetra-alkyl ester of pyromellitic acid (which may also be formed from pyromellitic anhydride) used in the lubricant herein may the general formula (I):

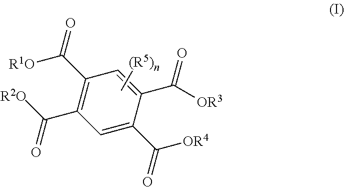

where each of R¹, R², R³, and R⁴ is independently an alkyl group, e.g., a C₅ to C₁₄ alkyl group, which can be branched or unbranched;
R⁵ is a C₁-C₅ hydrocarbyl group; and
n is from 0 to 2.

R¹, R², R³, and R⁴ can be the same or different. In one embodiment, they are the same.

In some embodiments, one or more (or all) of R¹, R², R³, and R⁴ is a Ce or higher, or a C₇ or higher alkyl group. In some embodiments, one or more of R¹, R², R³, and R⁴ is a C₁₂ or lower, or a C₁₀ or lower alkyl group. In one embodiment, each alkyl group is selected from linear and branched alkyl groups of 5 to 14 carbon atoms, and mixtures thereof. In one embodiment, the alkyl group is selected from linear and branched alkyl groups containing 6 to 10 carbon atoms, and mixtures thereof. In one embodiment, the alkyl group is selected from linear and branched alkyl groups of 8 to 10 carbon atoms, and mixtures thereof.

Example hydrocarbyl groups suited to use as R⁵ include C₁-C₅ alkyl groups and C₂-C₅ alkenyl groups, which can be linear or branched. In some embodiments, the hydrocarbyl groups may include heteroatoms and heteroatom substituents which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy). Representative alkyl and alkenyl groups include methyl, ethyl, propyl, butyl, butyl, butyl, and pentyl groups, unsaturated equivalents thereof, and the like.

In one embodiment, n is 0, i.e., R⁵ is absent.

Example tetra-alkyl esters of pyromellitic acid are those in which R¹, R², R³, and R⁴ are independently selected from linear or branched C7 alkyl groups, linear or branched C8 alkyl groups, linear or branched C9 alkyl groups, and linear or branched C10 alkyl groups, wherein R¹, R², R³, and R⁴ may be the same or different.

One example ester of pyromellitic acid is tetrakis(2-ethylhexyl)benzene-1,2,4,5-tetracarboxylate (“tetramellitate ester”), which has the formula (II):

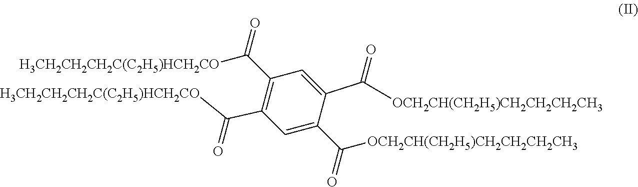

The tetra-alkyl ester of pyromellitic acid may be the only component of the lubricant (other than impurities). In other embodiments, the lubricant may further include one or more other lubricant oils and/or one or more additives. However, care should be used when adding other lubricant oils and/or additives so that the desirable properties of the tetra-alkyl ester relative to its use with the refrigerant is not unduly diminished.

Examples of other lubricant oils which may be used in the lubricant include a polyol ester, a polyol ether, a polyalphaolefin, a polyalkylene glycol a hydrocarbon oil, or a mixture thereof. Specific examples of polyol esters and polyol ethers which may be employed in the lubricant include (i) an aromatic ester comprising the reaction product of an aromatic hydrocarbon having at least one carboxylic functional group and a (mono)alkylalcohol and/or a glycol ether; (ii) a polyolester oil, wherein the polyolester oil comprises a polyol esterified with at least one (mono)carboxylic acid that has at least 5 carbon atoms; (iii) a polyol esterified with a mixture of (mono)carboxylic acids or their anhydrides, wherein the (mono)carboxylic acids or anhydrides, individually, have 5 to 13 carbon atoms; and mixtures thereof. Suitable polyols include trimethylolpropane, dipentaerythritol, neopentylglycol, monopentaerythritol, polypentaerythritol, and combinations thereof. In some embodiments, the polyol ester may comprise esters and/or complex esters of aromatic polycarboxylic acids or their anhydrides. The complex ester may be composed of polyol oligomeric units (such as trimethylolpropane, dipentaerythritol, neopentylglycol, monopentaerythritol, and/or polypentaerythritol), and a polyacid or acid anhydride (such as succinic, glutaric, adipic, citric, trimellitic, and/or pyromellitic). The complex ester may be fully or partially capped with functional (mono)carboxylic acids or (mono)alkylalcohols or singly-capped glycol ethers, or a mixture thereof.

In one embodiment, the lubricant contains, in total, no more than 10 wt. %, or no more than 5 wt. %, or no more than 2 wt. %, or no more than 1 wt. %, or no more than 0.1 wt. % of polyol ester(s) and polyol ether(s). In one embodiment, the lubricant is free or substantially free of polyol ester oils, wherein the polyol ester oil comprises a polyol esterified with at least one (mono)carboxylic acid that has at least 5 carbon atoms. In one embodiment, the lubricant contains no more than 5 wt. %, or no more than 1 wt. %, or no more than 0.1 wt. % of polyol ester oils, or no polyol ester oil.

The polyol ester and/or polyol ether, where present, may have a neat viscosity of at least 4 cSt or up to 400 cSt, measured at 40° C. according to ASTM D445-21. In other embodiments, the neat viscosity may be at least 5 cSt, or at least 10 cSt, or at least 30 cSt, or at least 100 cSt, or at least 170 cSt, or at least 200 cSt, or up to 350 cSt, or up to 200 cSt, or up to 170 cSt, measured at 40° C. according to ASTM D445-21. Example ranges include 200 to 400 cSt, 200 to 350 cSt, 170 to 200 cSt, 100 to 170 cSt, 32 to 120 cSt, 46 to 68 cSt, or 5 to 30 cSt, measured at 40° C. according to ASTM D445-21.

Example hydrocarbon oils include Ca-Cie alkanes and mixtures thereof, e.g., petroleum distillates, such as mineral oil, vegetable oils, and mixtures thereof. Where present, hydrocarbon oils, in total, may be no more than 10 wt. %, or no more than 5 wt. %, or no more than 2 wt. %, or no more than 1 wt. %, or no more than 0.1 wt. % of the lubricant.

In one embodiment, the lubricant contains, in total, no more than 10 wt. %, or no more than 5 wt. %, or no more than 2 wt. %, or no more than 1 wt. %, or no more than 0.1 wt. % of lubricant oils other than the tetra-alkyl ester(s) of pyromellitic acid or anhydride.

The lubricant (and/or the refrigerant) may further include one or more additional additives selected from antioxidants, corrosion inhibitors, anti-wear agents, extreme pressure (EP) additives, friction modifiers, foam inhibitors, viscosity modifiers, tackifiers, lubricity additives, surfactants, and combinations thereof. In one embodiment the additional additive(s), in total, are at least 0.005 wt. % or up to 0.5 wt. % of the lubricant (and/or the refrigerant).

Suitable antioxidants include butylated hydroxytoluene (BHT), butylatedhydroxyanisole (BHA), phenyl-a-naphthyl amine (PANA), octylated/butylated diphenyl amine, high molecular weight phenolic antioxidants, hindered bis-phenolic antioxidant, di-alpha-tocopherol, di-tertiary butyl phenol, and mixtures thereof.

In some embodiments, the antioxidant includes one or more of: (i) hexamethylene bis(3,5-di-tert-butyl-4-hydroxyhydrocinnamate), CAS registration number 35074-77-2, available commercially from BASF; (ii) N-phenylbenzenamine, reaction products with 2,4,4-trimethylpentene, CAS registration number 68411-46-1, available commercially from BASF; (iii) phenyl-α-naphthylamine and/or phenyl-b-naphthylamine, for example N-phenyl-ar-(1,1,3,3-tetramethylbutyl)-1-naphthalenamine, available commercially from BASF; (iv) tetrakis [methylene (3,5-di-tert-butyl-4-hydroxyhydrocinnamate)] methane, CAS registration number 6683-19-8; (v) thiodiethylenebis(3,5-di-tert-butyl-4-hydroxyhydrocinnamate), CAS registration number 41484-35-9, which is also listed as thiodiethylenebis(3,5-di-tert-butyl-4-hydroxy-hydro-cinnamate) (vi) butylated hydroxytoluene (BHT); (vii) butylated hydroxyanisole (BHA), (viii) bis(4-(1,1,3,3-tetramethylbutyl)phenyl)amine, available commercially from BASF; (ix) benzenepropanoic acid, 3,5-bis(1,1-dimethylethyl)-4-hydroxy-, thiodi-2,1-ethanediyl ester, available commercially from BASF.

The antioxidant(s) may be present in the lubricant at from 0.01 wt. % to 6.0 wt. %, or from 0.02 wt. % to 1 wt. %.

Suitable corrosion inhibitors include (i) triazoles or substituted triazoles, such as tolyltriazole (5-methyl-1H-benzotriazole); N,N-bis(2-ethylhexyl)-ar-methyl-1H-benzotriazole-1-methanamine, CAS registration number 94270-86-70, sold commercially by BASF under the trade name Irgamet™ 39; (ii) fatty acids derived from animal and/or vegetable sources, and/or the hydrogenated forms of such fatty acids, for example Neo-Fat™ which is commercially available from Akzo Nobel Chemicals, Ltd.; (iii) N-methyl-N-(1-oxo-9-octadecenyl)glycine, CAS registration number 110-25-8; (iv) phosphoric acid, mono- and diisooctyl esters, reacted with tert-alkyl and (C12-C14) primary amines, CAS registration number 68187-67-7; (v) dodecanoic acid; (vi) Triphenyl phosphorothionate, CAS registration number 597-82-0; and [0070] (v) phosphoric acid, mono- and dihexyl esters, compounds with tetramethylnonylamines and C11-14 alkylamines.

One useful additive is the N-acyl derivative of sarcosine, such as an N-acyl derivative of sarcosine. One example is N-methyl-N-(1-oxo-9-octadecenyl)glycine. This derivative is available from BASF under the trade name SARKOSYL™ O. Another additive is an imidazoline such as Amine O™ commercially available from Ciba-Geigy.

The corrosion inhibitors, where used, may be present in the lubricant at a concentration of at least 0.01 wt. %, or at least 0.02 wt. %, or to 6.0 wt. %, or up to 0.1 wt. %, or up to 0.05 wt. %.

To inhibit wear on the metal surfaces of the compressor, the lubricant may include one or more of an anti-wear agent, an extreme pressure (EP) additive, and a friction modifier. In some cases, a compound or composition may provide two or more of these functions. Anti-wear agents are polar additives that attach to frictional metal surfaces. They react chemically with the metal surfaces when metal-to-metal contact occurs in conditions of mixed and boundary lubrication and are activated by the heat of contact to form a film that minimizes wear. EP additives react chemically with metal (iron) surfaces to form a sacrificial surface film that reduces the likelihood of welding and seizure of opposing asperities caused by metal-to-metal contact. They are activated at high loads and by the high contact temperatures that are created. Example EP additives are sulfur compounds, phosphorus compounds and boron compounds. Friction modifiers are typically used to alter the friction between moving parts and can operate at lower loads that are not activated by contact temperatures. One product that can provide anti-wear, EP, reduced friction and corrosion inhibition is phosphorus amine salt such as Irgalube™ 349, which is available from BASF. Example anti-wear/EP inhibitor/friction modifiers are phosphorus compounds, such as triphenyl phosphothionate (TPPT), which is available from BASF as Irgalube™ TPPT; tricresyl phosphate (TCP), which is available from Chemtura as Kronitex™ TCP; and t-butylphenyl phosphate, which is available from ICL Industrial Products as Syn-O-Ad™ 8478.

The anti-wear agent, EP additive, and friction modifiers may be from 0.1 wt. % to 4 wt. % of the lubricant and may be used separately or in combination.

In some embodiments, the lubricant includes a viscosity modifier and/or a tackifier. Example viscosity modifiers include ethylene vinyl acetate, polybutenes, polyisobutylenes, polymethacrylates, olefin copolymers, esters of styrene maleic anhydride copolymers, hydrogenated styrene-diene copolymers, hydrogenated radial polyisoprene, alkylated polystyrene, fumed silicas, and complex ester. Example tackifiers include natural rubber solubilized in oil. The addition of a viscosity modifier and/or tackifier provides adhesiveness and improves the viscosity and viscosity index of the lubricant. Some applications and environmental conditions may require an additional tacky surface film that protects equipment from corrosion and wear. When used, the viscosity modifier, and/or tackifier may be at least 0.01 wt. %, or at least 0.05 wt. % or at least 0.1 wt. % of the lubricant, or up to 10 wt. %, or up to 5 wt. % of the lubricant. Example viscosity modifier/tackifiers include a natural rubber available from Functional Products, Inc., Macedonia, Ohio as Functional V-584™; and a complex ester available from Inolex Chemical Co. Philadelphia, Pa, as CG 5000™, which can also serve as a pour point depressant.

In some embodiments, chlorine-containing halocarbons can provide lubricity to the working fluid. These refrigerants can react chemically with metals in the refrigeration system to form protective surface films composed of metal chlorides.

Example surfactants include fluoro-surfactants, such as those sold under the tradename Novec™ FC-4434, from 3M.

Example foam modifiers include dimethyl polycyclohexane, polyacrylates, and mixtures thereof.

Example demulsifiers include condensed polymeric alcohols, esters of fatty acids, fatty alcohols alkoxylated with alkylene oxides, and mixtures thereof.

### The Working Fluid

The working fluid includes the tetra-alkyl ester of pyromellitic acid or pyromellitic dianhydride, a refrigerant, and optionally other components of the lubricating composition. A ratio by weight of the at least one the tetra-alkyl ester of pyromellitic acid and the tetra-alkyl ester of pyromellitic anhydride to the refrigerant in the working fluid may be from 1:99 to 99:1, or at least 5:95, or at least 10:90, at least within the compressor of a refrigerant system.

The refrigerant is a compound or compounds capable of maintaining a fluid state at temperatures over a range of at least −30 to 20° C. and which is able to undergo a repeated phase transition from a liquid to a gas and back again. The refrigerant is one which is sufficiently miscible with the tetra-alkyl ester of pyromellitic acid and/or dianhydride.

The refrigerant in the working fluid may comprise at least one halogenated carbon compound (a “halocarbon”). As used herein, a halocarbon can include any carbonaceous compound that has one or more carbon atoms that are bonded with one or more halogens. In one embodiment, the halocarbon in the refrigerant may comprise at least one of a hydrofluorocarbon, a hydrochlorocarbon, a hydrochlorofluorocarbon, and a chlorofluorocarbon, or a mixture thereof. In some embodiments, the halocarbon in the refrigerant may comprise at least one of a hydrofluoroolefin, a hydrochloroolefin, a hydrochlorofluoroolefin, a chlorofluoroolefin, or a mixture thereof.

As used herein, a low (or no) chlorine refrigerant (LCR) contains no more than 2 atomic percent of chlorine, or no more than 1 atomic percent of chlorine. A no chlorine refrigerant contains no more than 0.01 atomic percent of chlorine (i.e., any chlorine present results from impurities).

In one embodiment, the halocarbon component of the refrigerant is an LCR or a mixture of LCRs. In another embodiment, the halocarbon component of the refrigerant is predominantly, but not entirely LCR (at least 50 wt. % LCR, or at least 60 wt. % LCR, or at least 70 wt. % LCR, or at least 80 wt. % LCR, or at least 90 wt. % LCR, or up to 99 wt. % LCR). Put another way, a ratio of fluorine atoms to chlorine atoms in the refrigerant may be at least 1:1, or at least 2:1, or at least 3:1, or at least 4:1, or at least 5:1, or at least 6:1, or at least 10:1, or up to 99:1.

Suitable halocarbons for use in LCRs include hydrofluorocarbons, particularly HFOs (hydrofluoroolefins). HFOs are composed solely of hydrogen, fluorine and carbon atoms but contain at least one double bond between the carbon atoms. Example HFOs include propene-based HFOs, such as 2,3,3,3-tetrafluoropropene (chemical formula CH₂═CFCF₃) and which has the designation HFO 1234yf (or R-1234yf), with the optional further designation of E or Z for the trans or cis isomer, sold as Opteon™ YF by Chemours and as Solstice™ YF by Honeywell; 1,3,3,3-tetrafluoropropene (chemical formula CHF═CHCF₃), which may also be referred to as 1,1,1,3-tetrafluoropropene, and which has the designation HFO-1234ze (or R-1234ze), with the optional further designation of E or Z for the trans or cis isomer; 3,3,3-trifluoropropene (chemical formula CH₂═CHCF₃), which has the designation HFO-1243zf (or R1243zf), 1,2,3,3,3-pentafluoropropene (chemical formula HFC═C(F)CF₃) which has the designation HFO-1225ye, with the optional further designation of E or Z for the trans or cis Isomer; butene-based HFOs, such as 1,1,1,4,4,4-hexafluoro-but-2-ene (HFO-1336mzz with the optional further designation of E or Z for the trans or cis isomer), and 1,1,1,4,4,4-hexafluoro-but-2-ene (HFO-1336mzz or R-1336mzz, with the optional further designation of E or Z for the trans or cis isomer); and pentene-based HFOs, such as 1,1,1,4,4,5,5,5-octafluoropent-2-ene (HFO-1438mzz). Mixtures of HFOs can be employed in the refrigerant.

In one embodiment, the hydrofluoroolefin(s) constitute at least 80 wt. %, or at least 90 wt. %, or at least 95 wt. %, or 100 wt. % of all halocarbons in the refrigerant.

In some embodiments, the refrigerant may include at least one HFO and at least one hydrochloroolefin (HCO). HCOs are composed solely of hydrogen, chlorine and carbon atoms but contain at least one double bond between the carbon atoms. In one aspect of this embodiment, a ratio of HFO:HCO in the refrigerant is at least 1:1, or at least 2:1, or at least 2.5:1, or up to 99:1. Examples of HCOs include 1,2-dichloroethene (R-1130, with the optional further designation of E or Z for the trans or cis isomer). One example HFO:HCO mixture is designated R-514A, which is an azeotropic olefin blend comprising 74.7% cis-1,1,1,4,4,4-hexafluoro-but-2-ene and 25.3% trans-1,2-dichloroethene (R-1130 (E)), and which is sold under the tradename Opteon™ XP30 by Chemours.

In some embodiments, the refrigerant may include at least one HFO and at least one a hydrochlorofluoroolefin (HCFO). HCFOs are composed solely of hydrogen, chlorine, fluorine and carbon atoms but contain at least one double bond between the carbon atoms. In one aspect of this embodiment, a ratio of HFO:HCFO in the refrigerant is at least 2:1, or at least 3:1, or up to 99:1 (or higher). Examples of HCFOs include 1-chloro-3,3,3-trifluoropropene (HCFO-1233zd or R-1233zd, with the optional further designation of E or Z for the trans or cis isomer).

The refrigerant may further include one or more saturated halogenated carbon compounds (saturated halocarbons), for example hydrofluorocarbons and/or hydrochlorocarbons. Exemplary saturated halocarbons include trifluoromethane (R-23), difluoromethane (R-32), pentafluoroethane (R-125), 1,1,1,2-tetrafluoroethane (R-134a), 1,1,1-trifluoroethane (R-143a), 1,1-difluoroethane (R-152a), 1,2-difluoroethane, 1,1,1,2,3,3,3-heptafluoropropane (R-227ea), 1,1,1,3,3,3-hexafluroropropane (R-236fa), 1,1,1,3,3-pentafluoropropane (R-245fa), dichloromethane, trichlorofluoromethane, bromochlorodifluoromethane, dichlorodifluoromethane, chlorotrifluoromethane, trifluoroiodomethane, 1,1,2-trichloro-1,2,2-trifluoroethane, chloropentafluoroethane, 1-chloro-1,1-difluoroethane, octafluorocyclobutane, and mixtures thereof.

Where present, the halogenated carbon compounds(s) may be at least 0.01 wt. %, or at least 0.05 wt. %, or at least 0.1 wt. %, or at least 1 wt. %, or at least 2 wt. %, or at least 3 wt. % of the refrigerant, or up to 90 wt. %, or up to 50 wt. %, or up to 20 wt. %, or up to 10 wt. %, or up to 5 wt. % of the refrigerant, in total.

The refrigerant may further include one or more halogen-free organic compounds (organic compounds that include no halogen atoms). Suitable organic compounds are fluids at the operating temperature of the refrigeration system and may be selected from an alkane, an alkene, an alcohol, a glycol, an ether, a glycol ether, an oil of mineral origin, a silicone oil, a paraffin of natural origin, a naphthene, a synthetic paraffin, an alkylbenzene, a polyalphaolefin, a polyalkene glycol, a polyol ester, a polyvinyl ether, and mixtures thereof. Example alkanes include C₂-C₈ alkanes, such as propane, a butane, a pentane, a hexane, or a mixture thereof. Example alkenes include C₂-C₈ alkenes, such as a propene, a butene, a pentene, a hexene, or a mixture thereof. Example alcohols include C₂-C₈ alcohols, such as ethyl alcohol, a propyl alcohol, a butyl alcohol, a pentyl alcohol, a hexyl alcohol, or a mixture thereof. Example ethers include C₂-C₈ ethers, such as diethyl ether and ethylene glycol monobutyl ether (DGME).

Where present, the halogen-free organic compound(s) may be at least 0.01 wt. %, or at least 0.05 wt. %, or at least 0.1 wt. %, or at least 1 wt. %, or at least 2 wt. %, or at least 3 wt. % of the refrigerant, or up to 90 wt. %, or up to 50 wt. %, or up to 20 wt. %, or up to 10 wt. %, or up to 5 wt. % of the refrigerant, in total.

In some embodiments, the refrigerant may comprise carbon dioxide.

In some embodiments, the refrigerant may include a hydrofluoroolefin (HFO) and carbon dioxide. For example, refrigerant R463A is a mixture of hydrofluorocarbons, hydrocarbons, and carbon dioxide.

The working fluid may further include one or more additives which do not fall within the categories described above. Example additives include nanoparticles, stabilizers, surfactants, tracing agents, fluorescent agents, odorants and solubilizers.

In some embodiments, the tetra-alkyl ester of pyromellitic acid and hydrofluoroolefin, in combination, may be at least 90 wt. %, or at least 95 wt. %, or up to 100 wt. % of the working fluid.

Refrigerants useful herein may have a low Global Warming Potential (GWP). GWP is the heat absorbed by any greenhouse gas in the atmosphere. GWP values are calculated as a multiple of the heat that would be absorbed by the same mass of carbon dioxide (CO₂), which has been attributed a GWP value of 1. Example refrigerants and mixtures thereof may have a GWP of less than 50 or less than 10, or less than 5. For example, HFO-1234yf has a GWP of less than 1. By comparison, conventional HFC refrigerants, such as R-410A and R-404A have values of nearly 2,000 and 4,000 GWP, respectively.

The exemplary lubricant is miscible with the selected hydrofluorocarbon refrigerant or refrigerant blend over the operational temperatures of the compression refrigeration system. Miscibility of the lubricant with the refrigerant over operational temperatures ensures that the lubricant that enters into the refrigeration system out of the compressor can be carried through the evaporation orifice and heat transfer equipment back to the compressor where it functions as a lubricant and that a non-miscible lubricant portion is not present as blockage in the system restricting refrigerant movement through the system. It also assures that minimal lubricant oil films exist on the heat transfer equipment where it might interfere with the efficiency of heat transfer by acting as a thermal insulating film. While the necessary extent of miscibility of the lubricant and the refrigerant may vary depending upon application in embodiment, a desired range is from −20° C. to 80° C., or from −10° C. to 70° C. weight ratios of lubricant:refrigerant of 5:95, or 10:90, and/or 20:80.

The working fluid, which includes the lubricant and the refrigerant, may have a working viscosity at 323 K of at least 40 centistokes (cSt=mm²/s) at 3 bar or at least 8 cSt at 7 bar, or at least 8 cSt at 10 bar, or at least 3 cSt at 20 bar. The working fluid is able to withstand a range of temperatures, such as the high temperatures in the discharge area of the compressor.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the lubricant/working fluid in its intended use, may not be susceptible of easy description. Nevertheless, all such modifications and reaction products are included within the scope of the present invention; the present invention encompasses the composition prepared by admixing the components described above.

### Method of Preparing the Lubricant

In one embodiment, a method of preparing the lubricant includes (i) reacting pyromellitic acid and/or pyromellitic dianhydride with a branched or unbranched monohydric alkyl alcohol having from 5 to 14 carbon atoms, in a sufficient amount to form the tetra-alkyl ester, and optionally (ii) combining the tetra-alkyl ester of pyromellitic acid and/or pyromellitic dianhydride with one or more lubricant oils (I.e., other than the reaction product of step (i)), and/or one or more additives as described above.

The esterification can be performed by heating pyromellitic acid with the alkyl alcohol at a temperature of about 200 to 250° C., under reflux. The alky alcohol may be in excess over the stoichiometric amount, such as an excess of about 10%, or more. An esterification catalyst, such as sulfuric acid, may be employed, if desired. Water generated in the reaction and any residual alcohol are removed.

Pyromellitic acid is widely available commercially, from Sigma-Aldrich and others,

### Refrigeration System

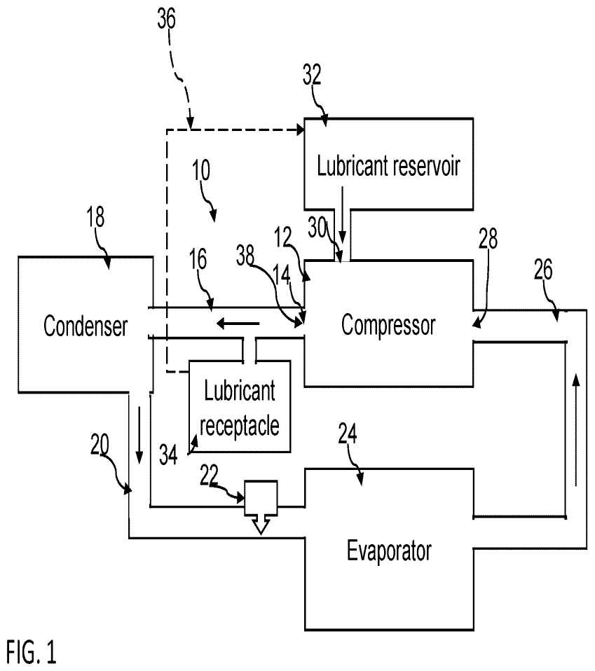

As illustrated in FIG. 1, in an exemplary refrigeration system 10, a refrigerant is compressed by a compressor 12 and directed, in a compressed gaseous state, from an outlet 14 of the compressor, through a first fluid line 16, to a condenser 18, where the compressed refrigerant gas is liquified, by cooling it. The liquified refrigerant passes through a second fluid line 20 to an expansion device 22, such as a valve, where the pressure of the refrigerant is reduced, lowering its temperature. The refrigerant then enters an evaporator 24, where the liquified refrigerant serves to remove heat from the surrounding atmosphere and, as a result, returns to a gaseous state. A third fluid line 26 carries the gaseous refrigerant back to the compressor, via a compressor inlet 28. A lubricant inlet 30 supplies the lubricant from a reservoir 32 to the moving parts of the compressor 12. The refrigerant picks up some of the lubricant while in the compressor, forming the working fluid, which carries some of the lubricant towards the condenser, a process referred to as entrapment. Generally, at least some of the lubricant is separated out from the compressed refrigerant. For example, a receptacle 34 collects the lubricant from the first fluid line 16 between the compressor and condenser. The collected lubricant may be returned to the lubricant inlet 30 of the compressor via a return line 36. Accordingly, other than within the compressor itself, the concentration of the lubricant in the working fluid is at its highest at a location 38 in the first fluid line 16 adjacent the outlet 14. At this location, the ratio of lubricant:refrigerant may be at least 1:99, or at least 5:95, or at least 10:90, or up to 40:60, or up to 30:70.

In another embodiment, a method of lubricating a compressor is disclosed. The method may include supplying to the compressor a working fluid including (a) a lubricant comprising (i) at least one tetra-ester of pyromellitic acid or pyromellitic dianhydride, and (b) a refrigerant.

In one embodiment, the components (a) and (b) are introduced separately to the compressor, for example, by introducing component (a) to the compressor while the refrigerant is passing through the compressor.

Methods of improving the working viscosity of a refrigerant for a refrigeration system are also disclosed. The method may comprise adding a lubricant, as described herein, to a refrigerant.

The present methods, systems and compositions are adaptable for use in connection with a wide variety of heat transfer systems in general and refrigeration systems in particular, such as air-conditioning (including both stationary and mobile air conditioning systems), refrigeration, heat-pump systems, and the like.

Blends of trimellitate esters with POE have been previously shown to reduce miscibility and solubility in HFO refrigerants. However, such a mixture tends to result in poor foaming properties and moderate wear properties. The tetra-alkyl esters derived from pyromellitic acid or anhydride, in contrast, have improved miscibility with HFO refrigerants, and improved wear and foaming properties when compared to POEs and trimellitate/POE blends.

Without intending to limit the scope of the exemplary embodiments, the following examples demonstrate the advantages of tetra-alkyl esters derived from pyromellitic acid or its anhydride.

### EXAMPLES

### Comparison of Tetrakis(2-ethylhexyl)benzene-1,2,4,5-tetracarboxylate with Polyol Esters and Polyol Ester/Trimellitate Blend

Tetrakis(2-ethylhexyl)benzene-1,2,4,5-tetracarboxylate (“Pyromellitate ester”) was obtained from Zimmer Schwarz.

Tri-isodecyltridecyl trimellitate diester was obtained from Teknor Apex Company as TruVis™ TM2200.

An ISO VG 220 synthetic polyol ester (POE) lubricant (Emkarate™ RL220H) formulated for use in refrigeration and air-conditioning compressors using HFC refrigerants was obtained from CPI Fluid Engineering. The RL220H POE has a Kinematic Viscosity, at 40° C., of 215 cSt, as determined according to ASTM D445-21.

A second polyol ester (Emkarate™ RL170H) was also obtained from CPI Fluid Engineering. The RL170H POE has a Kinematic Viscosity, at 40° C., of 170 cSt, as determined according to ASTM D445-21.

A first refrigerant, R-1234ze (E) (trans-1,1,1,3-tetrafluoropropene), manufactured by Honeywell and commercially available from Aspen Refrigerants.

A second refrigerant, R-514A (an azeotropic olefin blend comprising 74.7% cis-1,1,1,4,4,4-hexafluoro-RLbut-2-ene and 25.3% trans-1,2-dichloroethene (R-1130 (E)), manufactured by Chemours and commercially available from Aspen Refrigerants.

The compositions of lubricants evaluated are shown in Table 1. These compositions contained no additives.

TABLE 1
Lubricants (wt. %)

| | | Ex. B | | |
|---|---|---|---|---|
| | | (POE- | | |
| | Ex. A | RL220H/ | Ex. C | Ex. D |
| | (Pyromellitate | Trimellitate | (POE- | (POE- |
| Lubricant | ester) | blend) | RL170H) | RL220H) |
| Pyromellitate | 100 | | | |
| ester | | | | |
| RL220H | | 60 | | 100 |
| RL170H | | | 100 | |
| Trimellitate | | 40 | | |
| Ester-2200 | | | | |
| Total (wt. %) | 100 | 100 | 100 | 100 |

Physical properties of the neat lubricants are determined, as shown in Table 2, and include foam tendency and wear properties.

TABLE 2
Test Results

| Test and Method | Ex. A | Ex. B | Ex. C | Ex. D |
|---|---|---|---|---|
| Density @20° C., g/ml (ASTM D4052-22) | 0.992 | 0.969 | 0.968 | 0.975 |
| Appearance, visual observation | Clear | Clear | Clear | Clear |
| Kinematic Viscosity, KV40, cSt (ASTM | 173.45 | 225.64 | 162.2 | 226.21 |
| D445-21) | | | | |
| Kinematic Viscosity KV100, cSt (ASTM | 16.14 | 18.43 | 16.66 | 19.34 |
| D445-21) | | | | |
| Water, ppm (ASTM D6304-20) | <50 | <50 | <50 | <50 |
| Total Acid No. (TAN), mg KOH/g (ASTM | <0.05 | <0.05 | <0.05 | <0.05 |
| D974-21) | | | | |
| Flash Point, ° C. (ASTM D92-18) | 282 | 276 | 310 | 285 |
| Viscosity Index (ASTM D2270-10) | 96 | 90 | 109 | 97 |
| Color, Hazen units (ISO2211: 1973) | 26 | 34 | 55 | 107 |
| Four Ball Wear, scar diameter, mm (ASTM | 0.38 | 0.62 | 0.67 | 0.68 |
| D4172-21, A: at 1 hr., 15 Kg, 1200 RPM) | | | | |
| Falex EP Load to Fail, Pounds (ASTM | 1100 | 1000 | 1250 | 1200 |
| D3233-19, A) | | | | |
| Foaming Tendency, mL (ASTM D892-18, | 45 | 670 | 150 | 0 |
| Seq. I) | | | | |
| Foam Stability, mL (ASTM D892-18, Seq. | 0 | 600 | 0 | 0 |
| I, 10 min.) | | | | |
| Foaming Tendency, mL (ASTM D892-18, | 150 | 140 | 0 | 0 |
| Seq. II) | | | | |
| Foam Stability, mL (ASTM D892-18 Seq. | 0 | 0 | 0 | 0 |
| II, 10 min) | | | | |
| Foaming Tendency, mL(ASTM D892-18, | 35 | 550 | 90 | 0 |
| Seq. III) | | | | |
| Foam Stability, mL (ASTM D892-18, Seq | 0 | 370 | 0 | 0 |
| III (10 min) | | | | |
| Pour point, ° C. (ASTM D97-17b) | −42 | −36 | −34 | −30 |
| Copper Corrosion (ASTM D130-19) | 1A | 1A | 3B+ | 1A |

For reference, lower foaming tendency and four ball wear scar diameters are generally better for this application. Example A (pyromellitate ester without trimellitate ester) performs very well on both these tests.

Miscibility of the lubricant tetrakis(2-ethylhexyl)benzene-1,2,4,5-tetracarboxylate with refrigerant R-1234ze (E) and with refrigerant R-514A, under various conditions are shown in Table 3. Miscibility is determined in a bench test by combining the lubricant with the refrigerant in a tube, sealing the tube under a vacuum, agitating the tube, and observing the mixture at different temperatures. In Table 3, 1P is one phase, HZ is hazy (translucent), CL is cloudy (opaque). One phase and hazy are considered to be miscible, while cloudy is considered immiscible.

TABLE 3
Miscibility Results

| R-1234ze(E) | | | | | | | | |
|---|---|---|---|---|---|---|---|---|
| wt. % lubricant | | | | | | | | |
| in refrigeration | Ex. A | | Ex. B | | Ex. C | | Ex. D | |
| fluid | 10 | 20 | 10 | 20 | 10 | 20 | 10 | 20 |

Temp. (° C.)

| | | | | | | | | |
|---|---|---|---|---|---|---|---|---|
| 65 | 1P | HZ | 1P | 1P | 1P | 1P | 1P | 1P |
| 60 | 1P | HZ | 1P | 1P | 1P | 1P | 1P | 1P |
| 55 | 1P | HZ | 1P | 1P | 1P | 1P | 1P | 1P |
| 50 | 1P | 1P | 1P | 1P | 1P | 1P | 1P | 1P |
| 45 | 1P | 1P | 1P | 1P | 1P | 1P | 1P | 1P |
| 40 | 1P | 1P | 1P | 1P | 1P | 1P | 1P | 1P |
| 35 | 1P | 1P | 1P | 1P | 1P | 1P | 1P | 1P |
| 30 | 1P | 1P | 1P | 1P | 1P | 1P | 1P | 1P |
| 25 | 1P | 1P | 1P | 1P | 1P | 1P | 1P | 1P |
| 20 | 1P | 1P | 1P | 1P | 1P | 1P | 1P | 1P |
| 15 | 1P | HZ | 1P | 1P | 1P | 1P | 1P | 1P |
| 10 | 1P | HZ | 1P | 1P | 1P | 1P | 1P | 1P |
| 5 | 1P | HZ | 1P | 1P | 1P | 1P | 1P | 1P |
| 0 | 1P | HZ | 1P | 1P | 1P | 1P | 1P | 1P |
| −5 | 1P | HZ | 1P | 1P | 1P | 1P | 1P | 1P |
| −10 | 1P | CL | CL | CL | 1P | 1P | 1P | 1P |
| −15 | 1P | CL | CL | CL | 1P | 1P | 1P | 1P |
| −20 | HZ | CL | CL | CL | 1P | 1P | 1P | 1P |
| −25 | CL | CL | CL | CL | 1P | 1P | 1P | 1P |
| −30 | CL | CL | CL | CL | 1P | 1P | 1P | 1P |
| −35 | CL | CL | CL | CL | 1P | 1P | 1P | 1P |
| −40 | CL | CL | CL | CL | 1P | 1P | 1P | 1P |
| −45 | CL | CL | CL | CL | 1P | 1P | 1P | 1P |
| −50 | CL | CL | CL | CL | 1P | 1P | 1P | 1P |
| −55 | CL | CL | CL | CL | 1P | 1P | 1P | 1P |
| −60 | CL | CL | CL | CL | 1P | 1P | 1P | 1P |

A one phase (1P) result indicates that the lubricant is miscible in the refrigerant. Cloudy (CL) indicates that a there is lower miscibility. Ideally, the miscibility is good at temperatures operating in the evaporator, but less at lower temperatures. The results are particularly good for Exemplary composition A, when the lubricant is approximately 20 wt. % of the working fluid, particularly at the low temperatures to be expected in a refrigeration system. The data in Tables 2 and 3 indicates that Example A has an overall better foam tendency than Examples B and C, while having a comparable or improved solubility when compared to Examples B, C and D.

The working fluids are tested using a Pressure, Viscosity, and Temperature (“PVT”) apparatus. The PVT apparatus exposes the working fluids to various temperatures and pressures and provides solubility and Daniel plots. Procedures for using PVT apparatuses and generating solubility and Daniel plots are known in the art and can be generally summarized as follows. A working fluid is gravimetrically charged to the fluid reservoir of the PVT apparatus. The temperature and pressure of the fluid reservoir are changed and controlled with transducers. Once the fluid has been charged, a pump circulates the fluid through various measurement stages wherein various fluid properties, such as liquid density, solubility, circulating mass flowrate, and liquid viscosity (ASTM D7483-21), and vaporization are determined. The PVT apparatus may also have an observation window to allow the user to observe the working fluid during the test. The test conditions are controlled and the data recorded throughout the test through the aid of software. The software then uses the recorded data to generate the solubility and Daniel plots. Additional information for PVT apparatus testing may be found in Christopher J. Seeton and Pedrag Hrnjak, “Thermophysical Properties of CO₂-Lubricant Mixtures and Their Affect on 2-Phase Flow in Small Channels (Less than 1 mm),” Int'l Refrigeration and Air Conditioning Conf., Paper 774, pp. 1-8 (2006).

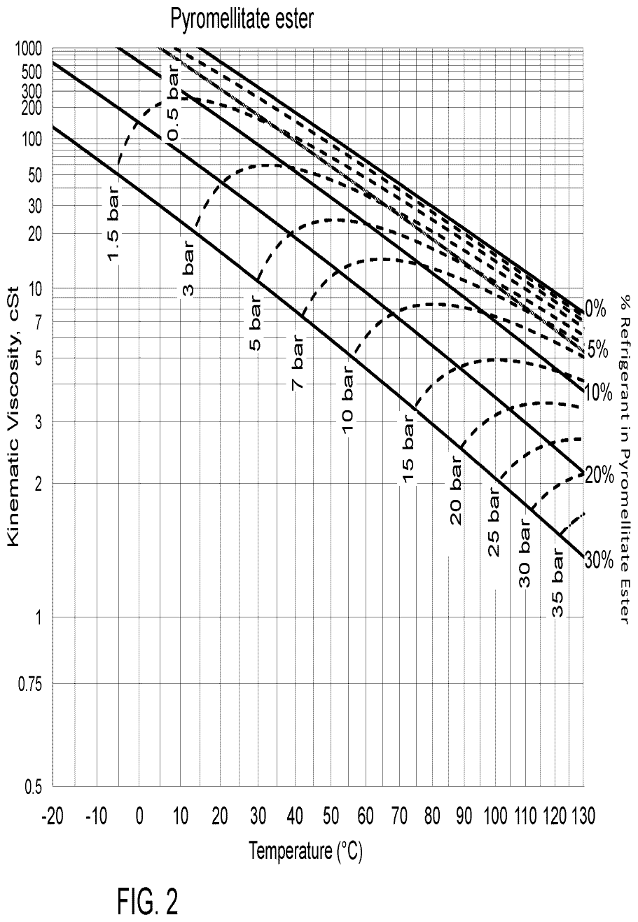

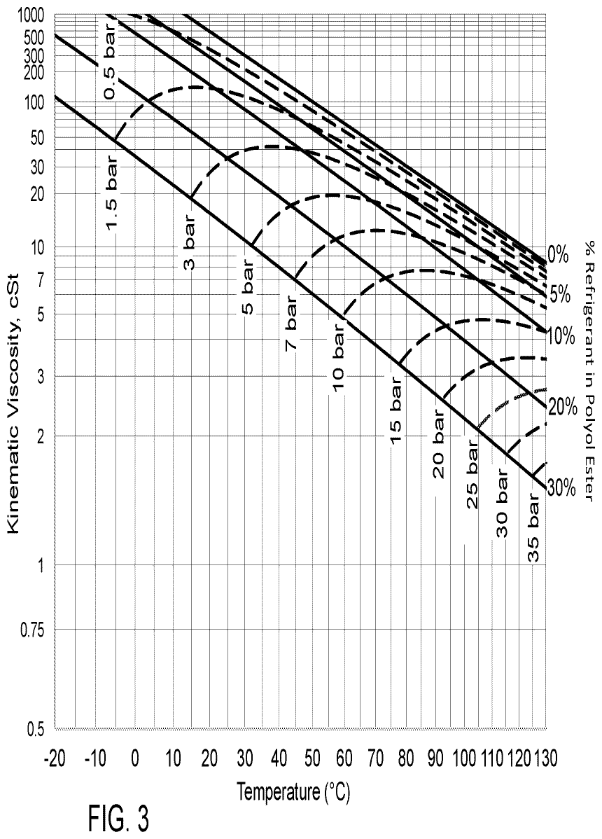

The Daniel plot shows the effect a refrigerant has at different concentrations on a lubricant's viscosity at a various temperatures and pressures. FIG. 2 is a Viscosity and Vapor Pressure Daniel Plot for a working fluid comprising the pyromellitate ester (Example A) in an HFO refrigerant (R-1234ze). FIGURE. 3 is a Viscosity and Vapor Pressure Daniel Plot for a working fluid comprising a polyol ester/trimellitate blend (Example B) with the same HFO refrigerant (R-1234ze). A comparison of FIG. 2 and FIG. 3 shows that the working fluid with pyromellitate ester (Example A) has higher kinematic viscosities than the working fluid with the polyol ester/trimellitate blend (Example B). Based on the plots, it can be expected that the pyromellitate ester is a more effective lubricant.

The PVT plots shown in FIGS. 2 and 3, and similar plots for Examples C and D, were used to determine dilutions and working viscosity under conditions of Interest.

Table 4 illustrates data obtained from the plots, where Dil. (%) is the percentage dilution and WV is the working viscosity. Two sets of conditions are shown. Condition 1 corresponds to a pressure of 12.4 bar and a temperature of 66° C., while Condition 2 corresponds to a pressure of 4.5 bar and 40° C.

TABLE 4
PVT Dilution and Working Viscosity at Conditions of Interest

| | Ex. A | | Ex. B | | Ex. C | | Ex. D | |
|---|---|---|---|---|---|---|---|---|
| | Dil. | WV | Dil. | WV | Dil. | WV | Dil. | WV |
| Condition | (%) | (cSt) | (%) | (cSt) | (%) | (cSt) | (%) | (cSt) |
| 1 | 29.4 | 4.11 | 30.2 | 4.26 | 38.3 | 2.15 | 41.9 | 1.94 |
| 2 | 16.3 | 27.1 | 17.8 | 26.2 | 21.1 | 17.7 | 21.1 | 17.1 |

The results suggest that at lower dilutions, equal or higher working viscosities can be achieved with the pyromellitate ester (Example A).

As will be appreciated under the operating conditions of a compressor in a refrigeration system, the results may differ.

Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention may be used together with ranges or amounts for any of the other elements.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A working fluid comprising a lubricant and a refrigerant, the lubricant comprising a tetra-alkyl ester of pyromellitic acid,
wherein a ratio by weight of the tetra-alkyl ester of pyromellitic acid to the refrigerant in the working fluid is from 90:10 to 99:1.

2. The working fluid of claim 1, wherein the tetra-alkyl ester of pyromellitic acid is at least 95 wt. % of the lubricant.

3. The working fluid of claim 1, wherein each alkyl in the tetra-alkyl ester of pyromellitic acid is selected from linear and branched alkyl groups comprising at least 5 carbon atoms, and mixtures thereof.

4. The working fluid of claim 1, wherein at least some of the alkyls in the tetra-alkyl ester of pyromellitic acid are selected from linear and branched alkyl groups comprising at least 6 carbon atoms.

5. The working fluid of claim 1, wherein the lubricant includes no more than 10 wt. % of polyol esters, polyol ethers, and mixture thereof.

6. The working fluid of claim 1, wherein a ratio of fluorine atoms to chlorine atoms in the refrigerant is at least 1:1.

7. The working fluid of claim 1, wherein the refrigerant comprises at least one hydrofluoroolefin.

8. The working fluid of claim 7, wherein the at least one hydrofluoroolefin is selected from the group consisting of 2,3,3,3-tetrafluoropropene; 1,3,3,3-tetrafluoropropene; 3,3,3-trifluoropropene; 1,2,3,3,3-pentafluoropropene; 1,1,1,4,4,4-hexafluoro-but-2-ene; 1,1,1,4,4,4-hexafluoro-but-2-ene; 1,1,1,4,4,5,5,5-octafluoropent-2-ene; and mixtures thereof.

9. The working fluid of claim 7, wherein the at least one hydrofluoroolefin is at least 80 wt. % of all halocarbons in the working fluid.

10. The working fluid of claim 7, wherein the tetra-alkyl ester of pyromellitic acid and hydrofluoroolefin together constitute at least 90 wt. % of the working fluid.

11. (canceled)

12. A method of lubricating a compressor of a refrigeration system, comprising forming a working fluid in the refrigeration system, the working fluid including a lubricant and a refrigerant, the lubricant comprising a tetra-alkyl ester of pyromellitic acid, the refrigerant comprising a hydrofluoroolefin, wherein in the compressor, a ratio by weight of the tetra-alkyl ester of pyromellitic acid to the refrigerant in the working fluid is from 90:10 to 99:1.

13. The method of claim 12, where the forming of the working fluid comprises supplying the lubricant to a compressor of the refrigeration system, the lubricant mixing with the refrigerant in the compressor to form the working fluid.

14. The method of claim 12, wherein in the compressor, the lubricant reaches a maximum concentration in the working fluid of at least 1 wt. %.

15. The method of claim 12, wherein the four alkyls of the tetra-alkyl ester of pyromellitic acid are selected from linear and branched alkyl groups comprising at least 5 carbon atoms, and mixtures thereof.

16. The method of claim 12, wherein each of the alkyls is independently selected from linear and branched alkyl groups comprising at least 6 carbon atoms.

17. A method of improving solubility of hydrofluoroolefin refrigerant in a working fluid comprising supplying a lubricant to the working fluid, the lubricant comprising a tetra-alkyl ester of pyromellitic acid, wherein a ratio by weight of the tetra-alkyl ester of pyromellitic acid to the refrigerant in the working fluid is from 90:10 to 99:1.

18. A method of reducing the occurrence of lubricant foam in an hydrofluoroolefin refrigerant in a compressor, comprising supplying a lubricant to the hydrofluoroolefin refrigerant, the lubricant comprising a tetra-alkyl ester of pyromellitic acid, wherein in the compressor, a ratio by weight of the tetra-alkyl ester of pyromellitic acid to the refrigerant in the working fluid is from 90:10 to 99:1.

19. The method of claim 18, wherein reduction of foam results from improved release of refrigerant vapor from the lubricant.

20. The working fluid of claim 1, wherein at least some of the alkyls in the tetra-alkyl ester of pyromellitic acid are selected from linear and branched alkyl groups comprising up to 14 carbon atoms.

21. The working fluid of claim 1, wherein the lubricant includes no more than 1 wt. % of polyol esters, polyol ethers, and mixture thereof.
